(19) United States
(12) Patent Application Publication
(10) Pub. No.: US 2024/0152823 A1
(43) Pub. Date: May 9, 2024

(54) LOGISTICS PROVIDER RECOMMENDATION USING MACHINE LEARNING

(71) Applicant: Dell Products L.P., Round Rock, TX (US)

(72) Inventors: Bijan Kumar Mohanty, Austin, TX (US); Satyam Sheshansh, Bangalore (IN); Hung Dinh, Austin, TX (US); Balaji Singh, Chennai (IN)

(21) Appl. No.: 17/980,906

(22) Filed: Nov. 4, 2022

(51) Int. Cl. G06N 20/20

(52) U.S. Cl. CPC G06N 20/20

(57) ABSTRACT

A method comprises receiving logistics operation order data, wherein the logistics operation order data identifies at least one logistics operation to be performed. The logistics operation order data is analyzed using one or more machine learning algorithms. Based at least in part on the analyzing, a logistics provider to perform the at least one logistics operation is predicted.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### FIELD

The field relates generally to information processing systems, and more particularly to logistics provider analysis in information processing systems.

### BACKGROUND

Logistics providers are critical to the successful delivery of products to customers. Typically, logistics providers are responsible for a variety of tasks in connection with product delivery and support. For example, logistics providers may handle the supply of components, as well as delivery of a finished product to a customer. In a support scenario, logistics providers may play a critical role in shipping a replacement for a defective part to a customer in order to ensure successful and timely resolution of an issue.

Different logistics providers may provide different levels of performance. In, for example, a large enterprise with many hundreds of logistics providers to choose from, logistics provider selection can be a difficult task and selection of a provider that is not equipped to handle particular circumstances may result in serious disruptions of the supply chain.

### SUMMARY

Embodiments provide a logistics provider prediction platform in an information processing system.

For example, in one embodiment, a method comprises receiving logistics operation order data, wherein the logistics operation order data identifies at least one logistics operation to be performed. The logistics operation order data is analyzed using one or more machine learning algorithms. Based at least in part on the analyzing, a logistics provider to perform the at least one logistics operation is predicted.

Further illustrative embodiments are provided in the form of a non-transitory computer-readable storage medium having embodied therein executable program code that when executed by a processor causes the processor to perform the above steps. Still further illustrative embodiments comprise an apparatus with a processor and a memory configured to perform the above steps.

These and other features and advantages of embodiments described herein will become more apparent from the accompanying drawings and the following detailed description.

### BRIEF DESCRIPTION OF THE DRAWINGS

FIG. 1 depicts an information processing system with a logistics provider prediction platform in an illustrative embodiment.

FIG. 2 depicts example logistics data sources according to an illustrative embodiment.

FIG. 3 depicts sample training data and corresponding features in an illustrative embodiment.

FIG. 4 depicts an operational flow for logistics provider prediction in an illustrative embodiment.

FIG. 5 depicts a screenshot illustrating progress of installation of a categorical boosting algorithm according to an illustrative embodiment.

FIG. 6 depicts example pseudocode for importation of libraries in an illustrative embodiment.

FIG. 7A depicts example pseudocode for reading historical resolution data into a data frame in an illustrative embodiment.

FIG. 7B depicts example training data in an illustrative embodiment.

FIG. 8A depicts example pseudocode for performing feature engineering on training data in an illustrative embodiment.

FIG. 8B depicts feature engineered training data in an illustrative embodiment.

FIG. 9 depicts example pseudocode for setting strings for auto-encoding of training data in an illustrative embodiment.

FIG. 10 depicts example pseudocode for splitting a dataset into training and testing components and for creating separate datasets for independent and dependent variables in an illustrative embodiment.

FIG. 11A depicts example pseudocode for building, training and computing accuracy of a categorical boosting classifier in an illustrative embodiment.

FIG. 11B depicts a screenshot of learning rate data for a categorical boosting classifier in an illustrative embodiment.

FIG. 12 depicts a process for logistics provider prediction according to an illustrative embodiment.

FIGS. 13 and 14 show examples of processing platforms that may be utilized to implement at least a portion of an information processing system according to illustrative embodiments.

### DETAILED DESCRIPTION

Illustrative embodiments will be described herein with reference to exemplary information processing systems and associated computers, servers, storage devices and other processing devices. It is to be appreciated, however, that embodiments are not restricted to use with the particular illustrative system and device configurations shown. Accordingly, the term “information processing system” as used herein is intended to be broadly construed, so as to encompass, for example, processing systems comprising cloud computing and storage systems, as well as other types of processing systems comprising various combinations of physical and virtual processing resources. An information processing system may therefore comprise, for example, at least one data center or other type of cloud-based system that includes one or more clouds hosting tenants that access cloud resources. Such systems are considered examples of what are more generally referred to herein as cloud-based computing environments. Some cloud infrastructures are within the exclusive control and management of a given enterprise, and therefore are considered “private clouds.” The term “enterprise” as used herein is intended to be broadly construed, and may comprise, for example, one or more businesses, one or more corporations or any other one or more entities, groups, or organizations. An “entity” as illustratively used herein may be a person or system. On the other hand, cloud infrastructures that are used by multiple enterprises, and not necessarily controlled or managed by any of the multiple enterprises but rather respectively controlled and managed by third-party cloud providers, are typically considered “public clouds.” Enterprises can choose to host their applications or services on private clouds, public clouds, and/or a combination of private and public clouds (hybrid clouds) with a vast array of computing resources attached to or otherwise a part of the infrastructure. Numerous other types of enterprise computing and storage systems are also encompassed by the term “information processing system” as that term is broadly used herein.

As used herein, “real-time” refers to output within strict time constraints. Real-time output can be understood to be instantaneous or on the order of milliseconds or microseconds. Real-time output can occur when the connections with a network are continuous and a user device receives messages without any significant time delay. Of course, it should be understood that depending on the particular temporal nature of the system in which an embodiment is implemented, other appropriate timescales that provide at least contemporaneous performance and output can be achieved.

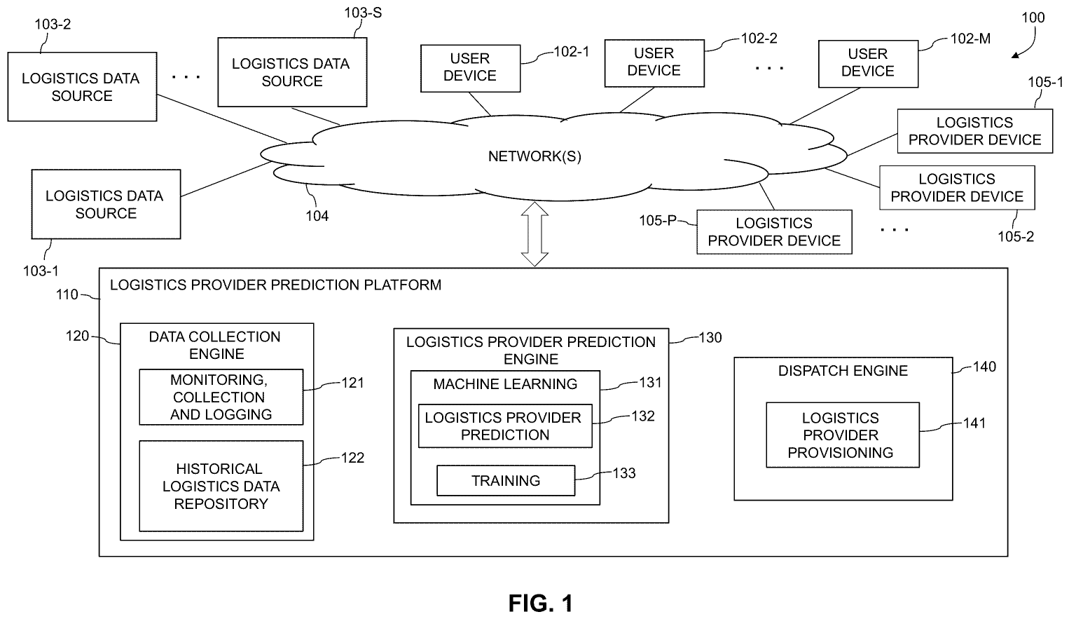

FIG. 1 shows an information processing system 100 configured in accordance with an illustrative embodiment. The information processing system 100 comprises user devices 102-1, 102-2, . . . 102-M (collectively “user devices 102”) and logistics provider devices 105-1, 105-2, . . . 105-P (collectively “logistics provider devices 105”). The user devices 102 and logistics provider devices 105 communicate over a network 104 with a logistics provider prediction platform 110. The variable M and other similar index variables herein such as K, L, S and P are assumed to be arbitrary positive integers greater than or equal to one.

The user devices 102 and logistics provider devices 105 can comprise, for example, Internet of Things (IoT) devices, desktop, laptop or tablet computers, mobile telephones, or other types of processing devices capable of communicating with the logistics provider prediction platform 110 over the network 104. Such devices are examples of what are more generally referred to herein as “processing devices.” Some of these processing devices are also generally referred to herein as “computers.” The user devices 102 and logistics provider devices 105 may also or alternately comprise virtualized computing resources, such as virtual machines (VMs), containers, etc. The user devices 102 and/or logistics provider devices 105 in some embodiments comprise respective computers associated with a particular company, organization or other enterprise.

The terms “customer,” “administrator,” “personnel” or “user” herein are intended to be broadly construed so as to encompass numerous arrangements of human, hardware, software or firmware entities, as well as combinations of such entities. Logistics provider prediction services may be provided for users utilizing one or more machine learning models, although it is to be appreciated that other types of infrastructure arrangements could be used. At least a portion of the available services and functionalities provided by the logistics provider prediction platform 110 in some embodiments may be provided under Function-as-a-Service (“FaaS”), Containers-as-a-Service (“CaaS”) and/or Platform-as-a-Service (“PaaS”) models, including cloud-based FaaS, CaaS and PaaS environments.

Although not explicitly shown in FIG. 1, one or more input-output devices such as keyboards, displays or other types of input-output devices may be used to support one or more user interfaces to the logistics provider prediction platform 110, as well as to support communication between the logistics provider prediction platform 110 and connected devices (e.g., user devices 102 and logistics provider devices 105) and/or other related systems and devices not explicitly shown.

In some embodiments, the user devices 102 are assumed to be associated with repair technicians, system administrators, information technology (IT) managers, software developers, release management personnel or other authorized personnel configured to access and utilize the logistics provider prediction platform 110. The user devices 102 can also be respectively associated with one or more customers requiring the services of one or more logistics providers.

As noted hereinabove, logistics providers may handle supply and delivery of components and finished products. Additionally, logistics providers can be integral to shipping replacements for defective parts and ensuring successful and timely resolution of device issues. Within a pool of possible logistics providers, some logistics providers may correspond to higher rates of particular problems (e.g., product and/or parts damage, delayed delivery, limited service areas, etc.) than others. As shipping and delivery requirements for products and/or parts can vary depending on priority, customer, product type and various other factors, the conventional rules-driven logic for selecting a logistics provider, which is based on a limited number of factors (e.g., availability and cost), is not sufficient to meet current enterprise demands.

In order to address the problems with current approaches, illustrative embodiments provide technical solutions which use machine learning to intelligently recommend an optimum logistics provider for delivering a product to a customer and/or for delivering parts, materials and other needed items for manufacturing or supporting a product. The machine learning models utilized by the embodiments are trained with historical logistics data including multi-dimensional order, shipping, work order, dispatch and outcome information. Advantageously, a machine learning based logistics provider prediction engine considers a multitude of features including, but not necessarily limited to, product, customer, priority, cost, damage history, ability to meet timelines, etc. to recommend an appropriate logistics provider for a given task. Selection of the appropriate logistics provider may be based on a variety of factors including, but not necessarily limited to, cost, on-time delivery and minimizing damage or other issues.

The logistics provider prediction platform 110 in the present embodiment is assumed to be accessible to the user devices 102 and/or logistics provider devices 105 and vice versa over the network 104. The network 104 is assumed to comprise a portion of a global computer network such as the Internet, although other types of networks can be part of the network 104, including a wide area network (WAN), a local area network (LAN), a satellite network, a telephone or cable network, a cellular network, a wireless network such as a WiFi or WiMAX network, or various portions or combinations of these and other types of networks. The network 104 in some embodiments therefore comprises combinations of multiple different types of networks each comprising processing devices configured to communicate using Internet Protocol (IP) or other related communication protocols.

As a more particular example, some embodiments may utilize one or more high-speed local networks in which associated processing devices communicate with one another utilizing Peripheral Component Interconnect express (PCIe) cards of those devices, and networking protocols such as InfiniBand, Gigabit Ethernet or Fibre Channel. Numerous alternative networking arrangements are possible in a given embodiment, as will be appreciated by those skilled in the art.

Referring to FIG. 1, the logistics provider prediction platform 110 includes a data collection engine 120, a logistics provider prediction engine 130 and a dispatch engine 140. The data collection engine 120 includes a monitoring, collection and logging layer 121 and a historical logistics data repository 122. The logistics provider prediction engine 130 includes a machine learning layer 131 comprising logistics provider prediction and training layers 132 and 133. The dispatch engine 140 includes a logistics provider provisioning layer 141.

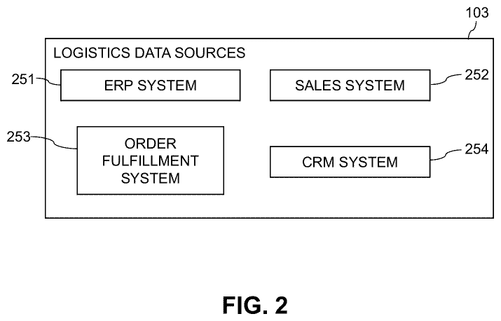

The monitoring, collection and logging layer 121 of the data collection engine 120 collects historical logistics data from one or more logistics data sources 103-1, 103-2, . . . , 103-S (collectively “logistics data sources 103”). Referring to FIG. 2, in a non-limiting illustrative embodiment, the logistics data sources 103 comprise, for example, one or more of an enterprise resource planning (ERP) system 251, a sales system 252, an order fulfillment system 253 (e.g., supply chain) and a customer relationship management (CRM) system 254.

The data may be collected from the logistics data sources 103 and/or from applications used for monitoring the logistics data sources 103. The historical logistics data comprises, for example, data from historical logistics operations (also referred to herein as “transactions”) including, but not necessarily limited to, parts procurement, product delivery, returns and parts dispatch for service. The historical logistics operations may correspond to a business enterprise or other organization. The monitoring, collection and logging layer 121 harvests the historical logistics data from the logistics data sources 103, and stores the harvested historical logistics data in the historical logistics data repository 122. In illustrative embodiments, harvesting the historical logistics data from the logistics data sources 103 comprises extracting features from the historical logistics data such as, for example, customer, product, type of transaction, location, region, and/or logistics operation outcomes (e.g., delay, damage, timely delivery, etc.).

In illustrative embodiments, the monitoring, collection and logging layer 121 performs data engineering and data pre-processing to identify the features and the corresponding data elements that will be influencing the logistics provider predictions for inputted logistics operations. In illustrative embodiments, the data engineering and data pre-processing includes generating multivariate plots and correlation heatmaps to identify the significance of each feature in the collected data, and filter less important data elements. The data engineering and data pre-processing reduces the dimensions and complexity of the machine learning model, hence improving the accuracy and performance of the model. In some embodiments, the data engineering and data pre-processing includes cleaning any unwanted characters and stop words from the historical logistics data, and performing stemming and lemmatization, as well as changing text to lower case, removing punctuation, and removing incorrect or unnecessary characters. The processed and engineered data is stored in the historical logistics data repository 122.

The historical logistics data repository 122 includes information such as, but not necessarily limited to, customer, product/part, type of transaction (e.g., product shipping, parts for manufacturing or service, etc.), date and time, location, region, logistics cost (e.g., high, medium, low), shipping issues (damage, delay, etc.) and/or the corresponding logistics provider. As explained in more detail herein, the historical logistics data from the historical logistics data repository 122 is used by the logistics provider prediction engine 130 to train a machine learning model to accurately predict a logistics provider for a newly received logistics operation that needs to be performed.

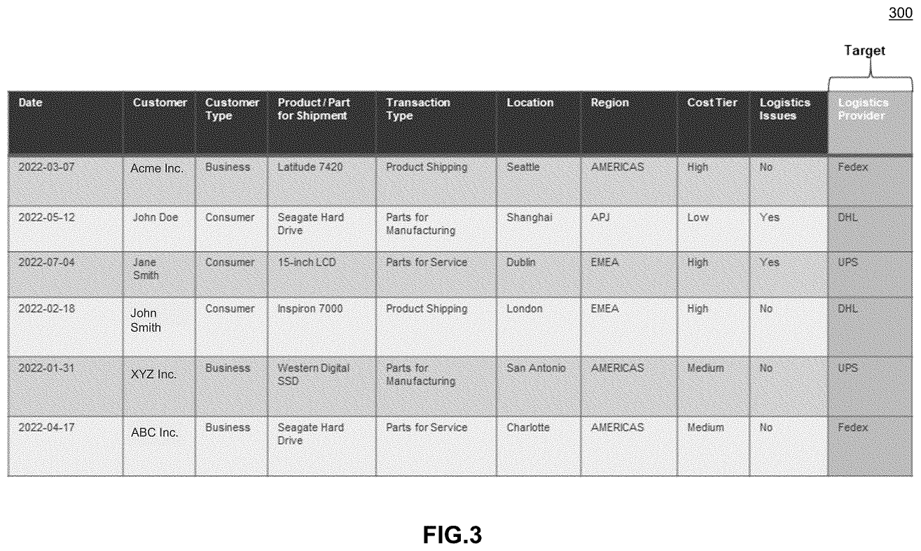

FIG. 3 depicts a table 300 of sample historical logistics data that may be used to train the one or more machine learning models used for logistics provider prediction by the logistics provider prediction engine 130. It is to be understood that the data illustrated in table 300 is illustrative, and the embodiments are not necessarily limited to what is shown in FIG. 3. Logistics data with more or less features may be used in other embodiments. As can be seen in the table 300, the training data identifies date, customer (e.g., customer name), customer type (e.g., business or individual consumer), product/part for shipment (e.g., product or part name), transaction type (e.g., product shipping, parts for manufacturing or parts for service), location (e.g., city), region (e.g., Americas, Asia-Pacific and Japan (APJ) or Europe, the Middle East and Africa (EMEA)), cost tier (e.g., low, medium or high), whether there were any issues (logistics issues) and logistics provider (e.g., Federal Express (FedEx, DHL, United Parcel Service (UPS)). The logistics providers are identified as a targets in the table 300, as the target variable that is being predicted by the machine learning layer 131 of the logistics provider prediction engine 130 is a logistics provider.

The logistics provider prediction engine 130, more particularly, the training layer 133 of the machine learning layer 131 uses the historical logistics data collected by the monitoring, collection and logging layer 121 to train one or more machine learning algorithms used by the logistics provider prediction layer 132 to predict a logistics provider to perform a given logistics operation. The predicted logistics provider is used by the dispatch engine 140, more particularly, the logistics provider provisioning layer 141, to generate a request for the predicted logistics provider to perform the given logistics operation. The request is transmitted, for example, over network 104 to one of the logistics provider devices 105 corresponding to the predicted logistics provider.

The logistics provider prediction layer 132 of the logistics provider prediction engine 130 predicts, with a high degree of accuracy, a logistics provider to perform a given logistics operation. The prediction is based, at least in part, a variety of features used in the training data received from the historical logistics data repository 122. Given the complexity and dimensionality of the logistics data, illustrative embodiments utilize a shallow learning approach leveraging a decision tree-based, ensemble boosting algorithm to handle large volumes of categorical data. Considering the target variable (logistics provider in this case) has many unique values (which can, for example, include hundreds of different logistics providers in large enterprises), illustrative embodiments utilize a boosting machine learning algorithm configured to process categorical data without requiring encoding of the categorical data. This machine learning algorithm comprises a categorical boosting (CatBoost) algorithm, which is a customized version of a gradient boosting algorithm that can process the categorical data in training datasets (e.g., historical logistics data comprising a variety of features) without using costly encoding mechanisms that may use large amounts of compute resources.

The logistics provider prediction engine 130, and more particularly, the training layer 133, uses a supervised learning approach for training with features that include, for example, date, customer, customer type, product/part, transaction type, location, region, cost tier, and whether there were any logistics issues. In illustrative embodiments, the logistics provider is the target variable to be predicted. When a new logistics operation to be performed is received at the logistics provider prediction platform 110 from, for example, a customer via a user device 102, details of the new logistics operation are input to a trained model of the machine learning layer 131 of the logistics provider prediction engine 130. The details of the new logistics operation comprise, for example, shipment type (e.g., ground, air, sea), priority (e.g., overnight, next day, standard), corresponding product/part, customer, relevant locations and/or regions (e.g., locations and/or regions shipping to and from), transaction type and/or desired cost.

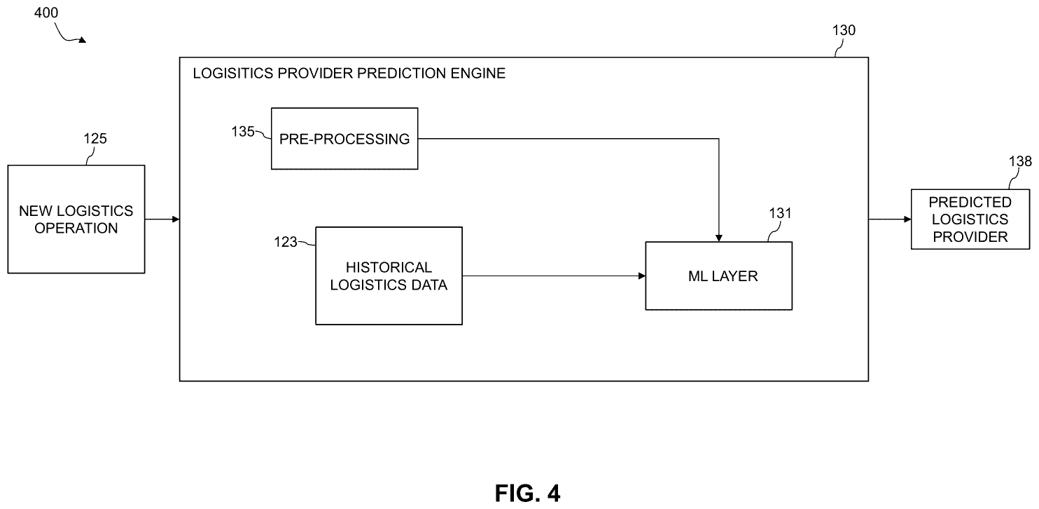

For example, referring to the operational flow 400 in FIG. 4, an order for a new logistics operation 125 including the details noted above is input to the logistics provider prediction engine 130. For example, a customer or enterprise personnel may request a logistics provider for a particular scenario, and input the requirements for a given operation via a user interface on, for example, one of the user devices 102. The order along with the details noted above (e.g., shipment type, priority, corresponding product/part, customer, relevant locations and/or regions, transaction type and/or desired cost) are provided to the logistics provider prediction engine 130 so that the logistics provider prediction layer 132 of the machine learning (ML) layer 131 can predict a logistics provider (predicted logistics provider 138) to perform the inputted new logistics operation 125. In some embodiments, the logistics provider prediction layer 132 predicts more than one logistics provider if multiple logistics providers can perform the new logistics operation 125 with the same or a similar result.

In illustrative embodiments, the logistics provider provisioning layer 141 of the dispatch engine 140 automatically generates a notification to the predicted logistics provider 138 or multiple predicted logistics providers (via, for example, logistics provider devices 105) requesting the services of the logistics provider with the details of the new logistics operation 125. In some cases, the logistics provider provisioning layer 141 of the dispatch engine 140 automatically generates a notifications to customers or enterprise personnel (via, for example, user devices 102) indicating the predicted logistics provider 138 or multiple predicted logistics providers with contact details of the logistics providers. In some embodiments, the logistics provider provisioning layer 141 automatically engages the predicted logistics provider 138 to perform the logistics transaction by processing the details of the logistics transaction and automatically scheduling the shipment and/or delivery by the predicted logistics provider 138 of the product/part.

Referring to FIG. 4, the logistics provider prediction engine 130 includes the machine learning (ML) layer 131, which leverages decision tree-based ensemble boosting algorithms and is trained with historical logistics data 123 from the historical logistics data repository 122 to accurately predict a logistics provider. In FIG. 4, the logistics provider prediction engine 130 illustrates a pre-processing component 135, which processes the data for the incoming new logistics operation 125 for analysis by the ML layer 131. For example, the pre-processing component 135 removes any unwanted characters, punctuation, and stop words. In addition, in illustrative embodiments, the pre-processing component 135 performs data engineering and data pre-processing as described above to identify the significance of each feature in a dataset so that less important data elements to the prediction are given less weight and/or are filtered.

As a shallow learning option, the embodiments utilize an ensemble boosting technique with categorical boosting for predicting the logistics provider class. The categorical boosting algorithm is used for prediction and recommendation because of its efficiency and accuracy of processing large volumes of data with categorical values (e.g., multiple categories/features) and the ability of the algorithm to use categorical data without encoding the datasets. Categorical boosting uses boosting to generate predictions; this includes sequentially using multiple classifiers each trained on different data samples and different features. This reduces the variance and the bias that results from using a single classifier. Final classification is achieved by aggregating the predictions that were made by the different classifiers. In the process of sequentially using the multiple classifiers, each sequential step corrects the errors from a previous step. For example, each classifier (e.g., decision tree) is trained using information from a previously trained classifier (e.g., decision tree) and by correcting identified errors from the test dataset of a previously trained classifier.

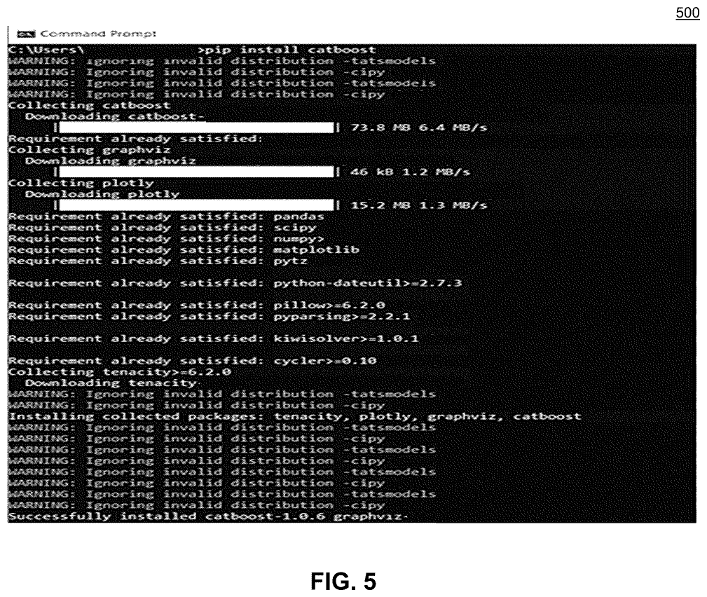

In illustrative embodiments, the categorical boosting combines several weak learners into a strong learner. For example, weak learners that use decision trees may make predictions that are slightly better than random predictions. By combining multiple weak learners and learning from the errors of each of the weak learners (e.g., each classifier fixing the errors of its predecessor), the algorithm improves the predictions in a sequential manner. The categorical boosting used in the illustrative embodiments processes categorical data without requiring previous encoding, and yields high performance and with relatively simple hyperparameter tuning. For example, the categorical boosting algorithm automatically encodes features for use in a training dataset. In some embodiments, a CatBoost algorithm available as an open source library can be installed with Python using the following command: “pip install catboost.” FIG. 5 depicts a screenshot 500 illustrating progress of installation of a categorical boosting algorithm.

According to illustrative embodiments, the categorical boosting algorithm used by the ML layer 131 includes multiple decision trees, and each decision tree is constructed using different features and different data samples from the historical logistics data 123, which reduces bias and variance. In the training process, the decision trees are constructed using the training data. In the testing process, each new prediction that needs to be made runs through the different decision trees, each decision tree yields a score and the final prediction in determined by voting (e.g., which class receives the most votes). The categorical boosting classifier uses multi-class classification, meaning the results of the classification would be one of a plurality of different logistic providers. Multiple independent variables (X values) comprise multiple features such as, but not necessarily limited to, shipment type, priority, corresponding product/part, customer, relevant locations and/or regions, transaction type, desired cost, etc., and the target variable (Y value) is the logistics provider.

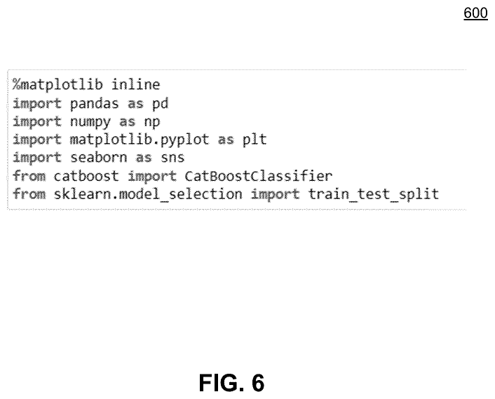

In connection with the operation of the logistics provider prediction engine 130, FIG. 6 depicts example pseudocode 600 for importation of libraries used to implement the logistics provider prediction engine 130. For example, Python, ScikitLearn, Pandas and Numpy libraries can be used. Illustrative embodiments implement multi-class classification using a CatBoost classifier to predict a logistics provider for optimized performance of a logistics transaction.

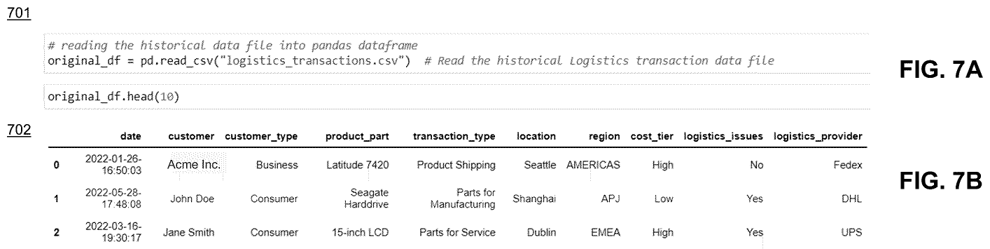

FIG. 7A depicts example pseudocode 701 for reading historical logistics data into a Pandas data frame for building training data. A historical logistics data file including historical logistics data for multiple logistics transactions is generated as a CSV file and the data is read to a Pandas data frame before displaying columns as in FIG. 7B. Similar to FIG. 3, FIG. 7B depicts a table 702 of example training data in an illustrative embodiment. As can be seen in the table 702, the training data identifies respective historical logistics operations with categories for date, customer, customer type, product/part for shipment, transaction type, location, region, cost tier, whether there were any logistics issues (Yes or No) and logistics provider. The data shown in the table 702 is a non-limiting example of the features of training data, and the embodiments are not necessarily limited to the depicted features.

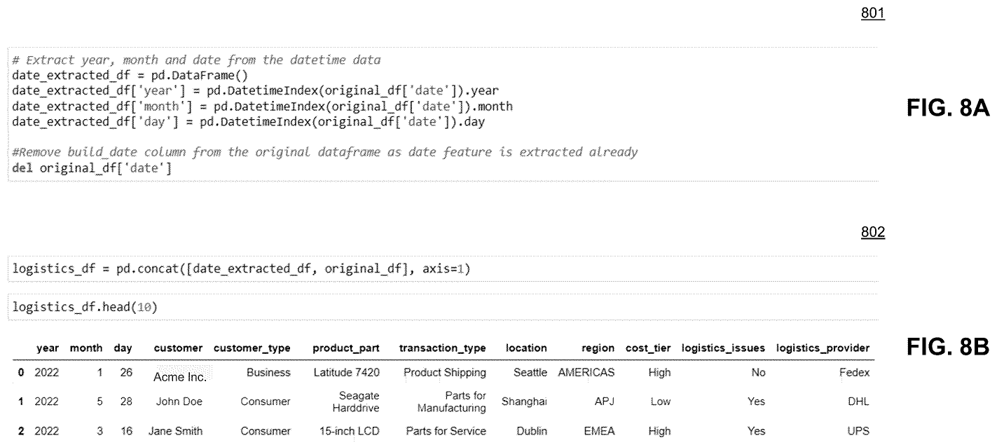

FIG. 8A depicts example pseudocode 801 for performing feature engineering on training data, and FIG. 8B depicts a table 802 of feature engineered training data. The date and/or time of a logistics transaction can play an important role in logistics provider prediction, as the date and/or time captures seasonality and how it affects logistics operations during certain periods (e.g., increased seasonal load due to, for example, holidays, weather in certain regions (e.g., rainy season, extreme cold or heat) and other factors). The pseudocode 801 implements feature engineering to extract and isolate, for example, year, month and day from dates as shown in the table 802. As can be understood, due to the importance of date information, for the algorithm to work more efficiently, a single column indicating a date (e.g., 2022-01-26) is reconfigured as three separate columns for year (2022), month (01) and day (26) in the table 802.

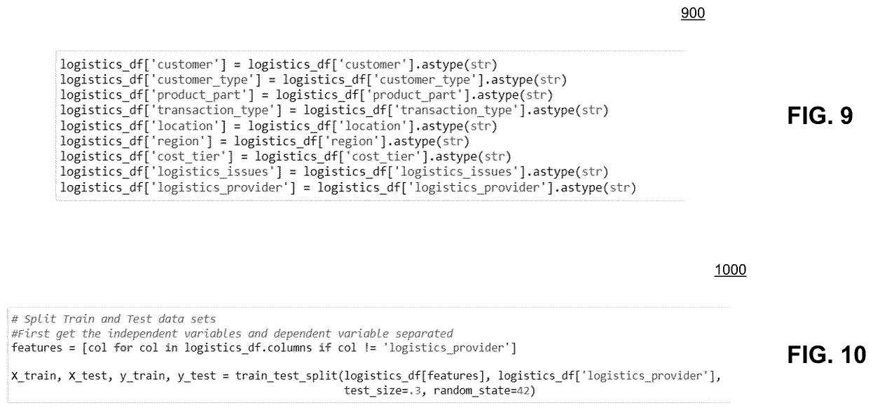

As noted above, with the categorical boosting algorithm, categorical values of the columns do need to be encoded. However, the columns must be set as strings for the algorithm to auto-encode the values. FIG. 9 depicts example pseudocode 900 for setting the columns as strings for auto-encoding of training data by the algorithm. As can be seen, the columns of customer, customer_type, product_part, transaction type, location, region, cost_tier, logistics_issues and logistics_provider are set as strings in the pseudocode 900.

According to illustrative embodiments, the training dataset is split into training and testing datasets, and separate datasets are created for independent variables and dependent variables. Some embodiments use a train_test_split function of an sklearn library to split the data into training and testing sets. The training set is used for training the machine learning model(s) while the test set is used for testing/validating and computing accuracy score(s) of the model(s). In some embodiments, a training set will contain 70% of the observations, while a testing set will contain 30% of the observations. The function also separates the dependent variables (X) and the independent/target variable (y). FIG. 10 depicts example pseudocode 1000 for splitting a dataset into training and testing components and for creating separate datasets for independent (X) and dependent/target (y) variables.

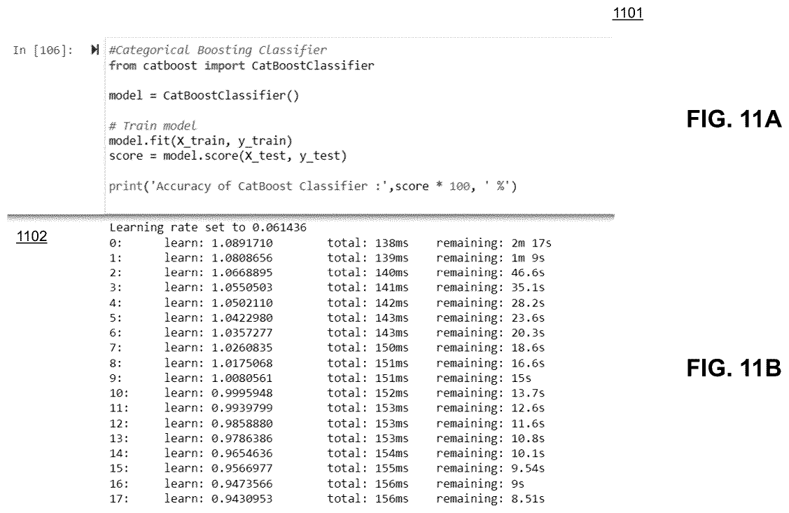

FIG. 11A depicts example pseudocode 1101 for building, training and computing accuracy of a categorical boosting classifier. In some embodiments, a categorical boosting algorithm is used to predict a logistics provider for a given logistics operation. The categorical boosting algorithm is an ensemble decision tree-based boosting algorithm, which is a customized version of a gradient boosting algorithm, and related to a random forest algorithm. Like the random forest algorithm, a gradient boosting algorithm uses multiple decision tree classifiers and then uses a mode value (or other averaging mechanism (e.g., mean, median, etc.)) of the outputs of the decision tree classifiers as the prediction. Unlike random forest techniques, which use parallel execution of multiple decision trees, categorical or gradient boosting techniques use sequential execution of multiple decision trees. In FIG. 11A, the accuracy of the categorical boosting classifier is 100%. FIG. 11B depicts a screenshot 1102 of learning rate data for a categorical boosting classifier that has been built and is being trained as per the pseudocode 1101 in FIG. 11A. The screenshot 1102 comprises a log of learning rate data for the categorical boosting classifier during training. A designated learning rate is used and several loops are used to train the model. The time taken for each loop is shown in the screenshot 1102.

According to one or more embodiments, the historical logistics data repository 122 and other data corpuses, repositories or databases referred to herein can be configured according to a relational database management system (RDBMS) (e.g., PostgreSQL). In some embodiments, the historical logistics data repository 122 and other data corpuses, repositories or databases referred to herein are implemented using one or more storage systems or devices associated with the logistics provider prediction platform 110. In some embodiments, one or more of the storage systems utilized to implement the historical logistics data repository 122 and other data corpuses, repositories or databases referred to herein comprise a scale-out all-flash content addressable storage array or other type of storage array.

The term “storage system” as used herein is therefore intended to be broadly construed, and should not be viewed as being limited to content addressable storage systems or flash-based storage systems. A given storage system as the term is broadly used herein can comprise, for example, network-attached storage (NAS), storage area networks (SANs), direct-attached storage (DAS) and distributed DAS, as well as combinations of these and other storage types, including software-defined storage.

Other particular types of storage products that can be used in implementing storage systems in illustrative embodiments include all-flash and hybrid flash storage arrays, software-defined storage products, cloud storage products, object-based storage products, and scale-out NAS clusters. Combinations of multiple ones of these and other storage products can also be used in implementing a given storage system in an illustrative embodiment.

Although shown as elements of the logistics provider prediction platform 110, the data collection engine 120, logistics provider prediction engine 130 and/or dispatch engine 140 in other embodiments can be implemented at least in part externally to the logistics provider prediction platform 110, for example, as stand-alone servers, sets of servers or other types of systems coupled to the network 104. For example, the data collection engine 120, logistics provider prediction engine 130 and/or dispatch engine 140 may be provided as cloud services accessible by the logistics provider prediction platform 110.

The data collection engine 120, logistics provider prediction engine 130 and/or dispatch engine 140 in the FIG. 1 embodiment are each assumed to be implemented using at least one processing device. Each such processing device generally comprises at least one processor and an associated memory, and implements one or more functional modules for controlling certain features of the data collection engine 120, logistics provider prediction engine 130 and/or dispatch engine 140.

At least portions of the logistics provider prediction platform 110 and the elements thereof may be implemented at least in part in the form of software that is stored in memory and executed by a processor. The logistics provider prediction platform 110 and the elements thereof comprise further hardware and software required for running the logistics provider prediction platform 110, including, but not necessarily limited to, on-premises or cloud-based centralized hardware, graphics processing unit (GPU) hardware, virtualization infrastructure software and hardware, Docker containers, networking software and hardware, and cloud infrastructure software and hardware.

Although the data collection engine 120, logistics provider prediction engine 130, dispatch engine 140 and other elements of the logistics provider prediction platform 110 in the present embodiment are shown as part of the logistics provider prediction platform 110, at least a portion of the data collection engine 120, logistics provider prediction engine 130, dispatch engine 140 and other elements of the logistics provider prediction platform 110 in other embodiments may be implemented on one or more other processing platforms that are accessible to the logistics provider prediction platform 110 over one or more networks. Such elements can each be implemented at least in part within another system element or at least in part utilizing one or more stand-alone elements coupled to the network 104.

It is assumed that the logistics provider prediction platform 110 in the FIG. 1 embodiment and other processing platforms referred to herein are each implemented using a plurality of processing devices each having a processor coupled to a memory. Such processing devices can illustratively include particular arrangements of compute, storage and network resources. For example, processing devices in some embodiments are implemented at least in part utilizing virtual resources such as virtual machines (VMs) or LXCs, or combinations of both as in an arrangement in which Docker containers or other types of LXCs are configured to run on VMs.

The term “processing platform” as used herein is intended to be broadly construed so as to encompass, by way of illustration and without limitation, multiple sets of processing devices and one or more associated storage systems that are configured to communicate over one or more networks.

As a more particular example, the data collection engine 120, logistics provider prediction engine 130, dispatch engine 140 and other elements of the logistics provider prediction platform 110, and the elements thereof can each be implemented in the form of one or more LXCs running on one or more VMs. Other arrangements of one or more processing devices of a processing platform can be used to implement the data collection engine 120, logistics provider prediction engine 130 and dispatch engine 140, as well as other elements of the logistics provider prediction platform 110. Other portions of the system 100 can similarly be implemented using one or more processing devices of at least one processing platform.

Distributed implementations of the system 100 are possible, in which certain elements of the system reside in one data center in a first geographic location while other elements of the system reside in one or more other data centers in one or more other geographic locations that are potentially remote from the first geographic location. Thus, it is possible in some implementations of the system 100 for different portions of the logistics provider prediction platform 110 to reside in different data centers. Numerous other distributed implementations of the logistics provider prediction platform 110 are possible.

Accordingly, one or each of the data collection engine 120, logistics provider prediction engine 130, dispatch engine 140 and other elements of the logistics provider prediction platform 110 can each be implemented in a distributed manner so as to comprise a plurality of distributed elements implemented on respective ones of a plurality of compute nodes of the logistics provider prediction platform 110.

It is to be appreciated that these and other features of illustrative embodiments are presented by way of example only, and should not be construed as limiting in any way. Accordingly, different numbers, types and arrangements of system elements such as the data collection engine 120, logistics provider prediction engine 130, dispatch engine 140 and other elements of the logistics provider prediction platform 110, and the portions thereof can be used in other embodiments.

It should be understood that the particular sets of modules and other elements implemented in the system 100 as illustrated in FIG. 1 are presented by way of example only. In other embodiments, only subsets of these elements, or additional or alternative sets of elements, may be used, and such elements may exhibit alternative functionality and configurations.

For example, as indicated previously, in some illustrative embodiments, functionality for the logistics provider prediction platform can be offered to cloud infrastructure customers or other users as part of FaaS, CaaS and/or PaaS offerings.

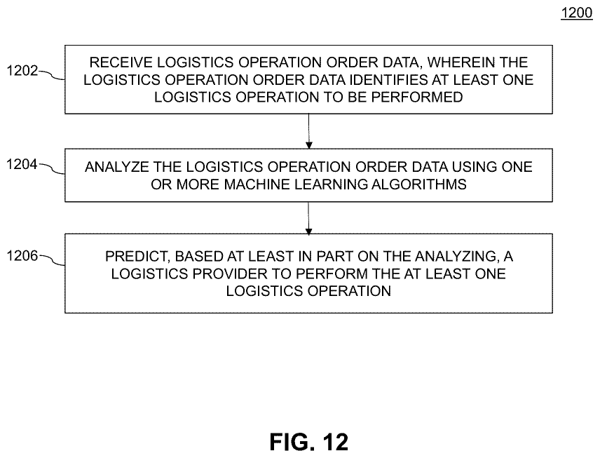

The operation of the information processing system 100 will now be described in further detail with reference to the flow diagram of FIG. 12. With reference to FIG. 12, a process 1200 for logistics provider prediction as shown includes steps 1202 through 1206, and is suitable for use in the system 100 but is more generally applicable to other types of information processing systems comprising a logistics provider prediction platform configured for predicting logistics providers to perform logistics operations.

In step 1202, logistics operation order data is received. The logistics operation order data identifies at least one logistics operation to be performed and includes details (e.g., shipment type, priority, corresponding product/part, customer, relevant locations and/or regions, transaction type and/or desired cost for the at least one logistics operation.

In step 1204, the logistics operation order data is analyzed using one or more machine learning algorithms. In step 1206, based at least in part on the analyzing, a logistics provider to perform the at least one logistics operation is predicted. Based at least in part on the predicting, a request for the logistics provider to perform the at least one logistics operation is generated, wherein the request is transmitted to the logistics provider.

The one or more machine learning algorithms are trained with historical logistics data. In illustrative embodiments, the historical logistics data specifies a plurality of logistics operations associated with respective ones of a plurality of logistics providers, and whether there were any issues with respective ones of the plurality of logistics operations. The historical logistics data specifies one or more features associated with the respective ones of the plurality of logistics operations, wherein the one or more features include at least one of date, customer, product, product part, logistics operation type, location and cost level. The historical logistics data is harvested from at least one of a customer relationship management system, an enterprise resource planning system, a sales system and an order fulfillment system.

In illustrative embodiments, the one or more machine learning algorithms automatically encode the one or more features for use in a training dataset. In addition, one or more sub-features are extracted from the one or more features to be used during the training. For example, as described herein, year, month and day may be extracted from the date and presented as separate columns a training dataset.

The one or more machine learning algorithms comprise a plurality of decision trees, and the plurality of decision trees are respectively trained with different portions of the historical logistics data. In one or more embodiments, the logistics operation order data is sequentially analyzed with respective ones of the plurality of decision trees to generate respective predictions. The respective predictions are aggregated to determine the logistics provider to perform the at least one logistics operation.

The one or more machine learning algorithms comprise an ensemble decision tree-based boosting algorithm such as, for example, a categorical boosting algorithm. The one or more machine learning algorithms may also be a shallow learning algorithm.

It is to be appreciated that the FIG. 12 process and other features and functionality described above can be adapted for use with other types of information systems configured to execute logistics provider prediction services in a logistics provider prediction platform or other type of platform.

The particular processing operations and other system functionality described in conjunction with the flow diagram of FIG. 12 are therefore presented by way of illustrative example only, and should not be construed as limiting the scope of the disclosure in any way. Alternative embodiments can use other types of processing operations. For example, the ordering of the process steps may be varied in other embodiments, or certain steps may be performed at least in part concurrently with one another rather than serially. Also, one or more of the process steps may be repeated periodically, or multiple instances of the process can be performed in parallel with one another.

Functionality such as that described in conjunction with the flow diagram of FIG. 12 can be implemented at least in part in the form of one or more software programs stored in memory and executed by a processor of a processing device such as a computer or server. As will be described below, a memory or other storage device having executable program code of one or more software programs embodied therein is an example of what is more generally referred to herein as a “processor-readable storage medium.”

Illustrative embodiments of systems with a logistics provider prediction platform as disclosed herein can provide a number of significant advantages relative to conventional arrangements. For example, the logistics provider prediction platform uses machine learning to predict and automatically select logistics providers for in connection with product and/or parts manufacturing, delivery, return and support. The embodiments advantageously leverage sophisticated machine learning classification techniques that are trained using multi-dimensional, historical logistics data to predict logistics providers that will avoid logistics operation issues (e.g., damage and delay).

Unlike conventional approaches, illustrative embodiments provide technical solutions which train a sophisticated decision tree-based categorical boosting algorithm with historical logistics data from supply chain, manufacturing and support systems. Due to the potentially large pools of logistics providers and various types of logistical transactions, the historical logistics data includes multi-dimensional features such as, but not necessarily limited to, customers, products, parts, locations, priorities, damage occurrences, delivery outcomes, etc. The multi-faceted training data advantageously trains the machine learning models of the illustrative embodiments to accurately predict logistics providers for a variety of logistics operations.

Current one-size-all rule and heuristics-based approaches for selection of a logistics provider engage in superficial analysis of a minimal number of factors which may not be relevant to a given logistics operation. The current techniques do not provide useful recommendations, and are not scalable to meet the demands of large enterprises that may be choosing from hundreds or thousands of logistics providers.

To address these technical problems, the embodiments provide technical solutions which formulate programmatically and with a high degree of accuracy the capability to use specialized machine learning algorithms to intelligently predict logistics providers that will yield optimal results for multiple types of logistics scenarios with different circumstances. By training multiple decision tree classifiers with different data, the categorical boosting algorithm of the illustrative embodiments advantageously analyzes large volumes of data with multiple categorical values to efficiently and accurately predict optimal logistics provider for multiple scenarios and specified needs.

It is to be appreciated that the particular advantages described above and elsewhere herein are associated with particular illustrative embodiments and need not be present in other embodiments. Also, the particular types of information processing system features and functionality as illustrated in the drawings and described above are exemplary only, and numerous other arrangements may be used in other embodiments.

As noted above, at least portions of the information processing system 100 may be implemented using one or more processing platforms. A given such processing platform comprises at least one processing device comprising a processor coupled to a memory. The processor and memory in some embodiments comprise respective processor and memory elements of a virtual machine or container provided using one or more underlying physical machines. The term “processing device” as used herein is intended to be broadly construed so as to encompass a wide variety of different arrangements of physical processors, memories and other device components as well as virtual instances of such components. For example, a “processing device” in some embodiments can comprise or be executed across one or more virtual processors. Processing devices can therefore be physical or virtual and can be executed across one or more physical or virtual processors. It should also be noted that a given virtual device can be mapped to a portion of a physical one.

Some illustrative embodiments of a processing platform that may be used to implement at least a portion of an information processing system comprise cloud infrastructure including virtual machines and/or container sets implemented using a virtualization infrastructure that runs on a physical infrastructure. The cloud infrastructure further comprises sets of applications running on respective ones of the virtual machines and/or container sets.

These and other types of cloud infrastructure can be used to provide what is also referred to herein as a multi-tenant environment. One or more system elements such as the logistics provider prediction platform 110 or portions thereof are illustratively implemented for use by tenants of such a multi-tenant environment.

As mentioned previously, cloud infrastructure as disclosed herein can include cloud-based systems. Virtual machines provided in such systems can be used to implement at least portions of one or more of a computer system and a logistics provider prediction platform in illustrative embodiments. These and other cloud-based systems in illustrative embodiments can include object stores.

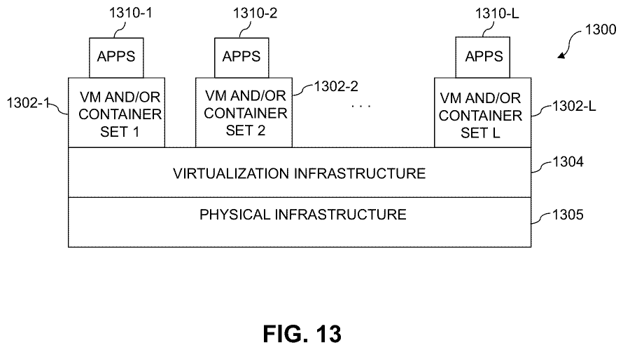

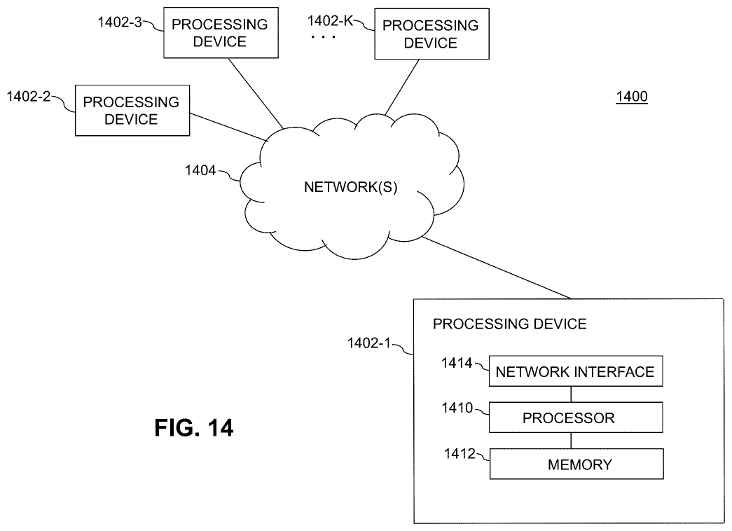

Illustrative embodiments of processing platforms will now be described in greater detail with reference to FIGS. 13 and 14. Although described in the context of system 100, these platforms may also be used to implement at least portions of other information processing systems in other embodiments.

FIG. 13 shows an example processing platform comprising cloud infrastructure 1300. The cloud infrastructure 1300 comprises a combination of physical and virtual processing resources that may be utilized to implement at least a portion of the information processing system 100. The cloud infrastructure 1300 comprises multiple virtual machines (VMs) and/or container sets 1302-1, 1302-2, . . . 1302-L implemented using virtualization infrastructure 1304. The virtualization infrastructure 1304 runs on physical infrastructure 1305, and illustratively comprises one or more hypervisors and/or operating system level virtualization infrastructure. The operating system level virtualization infrastructure illustratively comprises kernel control groups of a Linux operating system or other type of operating system.

The cloud infrastructure 1300 further comprises sets of applications 1310-1, 1310-2, . . . 1310-L running on respective ones of the VMs/container sets 1302-1, 1302-2, . . . 1302-L under the control of the virtualization infrastructure 1304. The VMs/container sets 1302 may comprise respective VMs, respective sets of one or more containers, or respective sets of one or more containers running in VMs.

In some implementations of the FIG. 13 embodiment, the VMs/container sets 1302 comprise respective VMs implemented using virtualization infrastructure 1304 that comprises at least one hypervisor. A hypervisor platform may be used to implement a hypervisor within the virtualization infrastructure 1304, where the hypervisor platform has an associated virtual infrastructure management system. The underlying physical machines may comprise one or more distributed processing platforms that include one or more storage systems.

In other implementations of the FIG. 13 embodiment, the VMs/container sets 1302 comprise respective containers implemented using virtualization infrastructure 1304 that provides operating system level virtualization functionality, such as support for Docker containers running on bare metal hosts, or Docker containers running on VMs. The containers are illustratively implemented using respective kernel control groups of the operating system.

As is apparent from the above, one or more of the processing modules or other components of system 100 may each run on a computer, server, storage device or other processing platform element. A given such element may be viewed as an example of what is more generally referred to herein as a “processing device.” The cloud infrastructure 1300 shown in FIG. 13 may represent at least a portion of one processing platform. Another example of such a processing platform is processing platform 1400 shown in FIG. 14.

The processing platform 1400 in this embodiment comprises a portion of system 100 and includes a plurality of processing devices, denoted 1402-1, 1402-2, 1402-3, . . . 1402-K, which communicate with one another over a network 1404.

The network 1404 may comprise any type of network, including by way of example a global computer network such as the Internet, a WAN, a LAN, a satellite network, a telephone or cable network, a cellular network, a wireless network such as a WiFi or WiMAX network, or various portions or combinations of these and other types of networks.

The processing device 1402-1 in the processing platform 1400 comprises a processor 1410 coupled to a memory 1412. The processor 1410 may comprise a microprocessor, a microcontroller, an application-specific integrated circuit (ASIC), a field-programmable gate array (FPGA), a central processing unit (CPU), a graphical processing unit (GPU), a tensor processing unit (TPU), a video processing unit (VPU) or other type of processing circuitry, as well as portions or combinations of such circuitry elements.

The memory 1412 may comprise random access memory (RAM), read-only memory (ROM), flash memory or other types of memory, in any combination. The memory 1412 and other memories disclosed herein should be viewed as illustrative examples of what are more generally referred to as “processor-readable storage media” storing executable program code of one or more software programs.

Articles of manufacture comprising such processor-readable storage media are considered illustrative embodiments. A given such article of manufacture may comprise, for example, a storage array, a storage disk or an integrated circuit containing RAM, ROM, flash memory or other electronic memory, or any of a wide variety of other types of computer program products. The term “article of manufacture” as used herein should be understood to exclude transitory, propagating signals. Numerous other types of computer program products comprising processor-readable storage media can be used.

Also included in the processing device 1402-1 is network interface circuitry 1414, which is used to interface the processing device with the network 1404 and other system components, and may comprise conventional transceivers.

The other processing devices 1402 of the processing platform 1400 are assumed to be configured in a manner similar to that shown for processing device 1402-1 in the figure.

Again, the particular processing platform 1400 shown in the figure is presented by way of example only, and system 100 may include additional or alternative processing platforms, as well as numerous distinct processing platforms in any combination, with each such platform comprising one or more computers, servers, storage devices or other processing devices.

For example, other processing platforms used to implement illustrative embodiments can comprise converged infrastructure.

It should therefore be understood that in other embodiments different arrangements of additional or alternative elements may be used. At least a subset of these elements may be collectively implemented on a common processing platform, or each such element may be implemented on a separate processing platform.

As indicated previously, components of an information processing system as disclosed herein can be implemented at least in part in the form of one or more software programs stored in memory and executed by a processor of a processing device. For example, at least portions of the functionality of one or more elements of the logistics provider prediction platform 110 as disclosed herein are illustratively implemented in the form of software running on one or more processing devices.

It should again be emphasized that the above-described embodiments are presented for purposes of illustration only. Many variations and other alternative embodiments may be used. For example, the disclosed techniques are applicable to a wide variety of other types of information processing systems and logistics provider prediction platforms. Also, the particular configurations of system and device elements and associated processing operations illustratively shown in the drawings can be varied in other embodiments. Moreover, the various assumptions made above in the course of describing the illustrative embodiments should also be viewed as exemplary rather than as requirements or limitations of the disclosure. Numerous other alternative embodiments within the scope of the appended claims will be readily apparent to those skilled in the art.

What is claimed is:

1. A method comprising:
receiving logistics operation order data, wherein the logistics operation order data identifies at least one logistics operation to be performed;
analyzing the logistics operation order data using one or more machine learning algorithms; and
predicting, based at least in part on the analyzing, a logistics provider to perform the at least one logistics operation;
wherein the steps of the method are executed by a processing device operatively coupled to a memory.

2. The method of claim 1 further comprising generating, based at least in part on the predicting, a request for the logistics provider to perform the at least one logistics operation, wherein the request is transmitted to the logistics provider.

3. The method of claim 1 further comprising training the one or more machine learning algorithms with historical logistics data.

4. The method of claim 3 wherein the historical logistics data specifies a plurality of logistics operations associated with respective ones of a plurality of logistics providers, and whether there were any issues with respective ones of the plurality of logistics operations.

5. The method of claim 4 wherein the historical logistics data specifies one or more features associated with the respective ones of the plurality of logistics operations, and wherein the one or more features include at least one of date, customer, product, product part, logistics operation type, location and cost level.

6. The method of claim 3 wherein:
the historical logistics data specifies one or more features associated with respective ones of a plurality of logistics operations; and
the one or more machine learning algorithms automatically encode the one or more features for use in a training dataset.

7. The method of claim 3 wherein:
the historical logistics data specifies one or more features associated with respective ones of a plurality of logistics operations; and
the method further comprises extracting one or more sub-features from the one or more features to be used during the training.

8. The method of claim 3 wherein the one or more machine learning algorithms comprise a plurality of decision trees, and the plurality of decision trees are respectively trained with different portions of the historical logistics data.

9. The method of claim 8 wherein the analyzing comprises:
sequentially analyzing the logistics operation order data with respective ones of the plurality of decision trees to generate respective predictions; and
aggregating the respective predictions to determine the logistics provider to perform the at least one logistics operation.

10. The method of claim 3 further comprising harvesting the historical logistics data from at least one of a customer relationship management system, an enterprise resource planning system, a sales system and an order fulfillment system.

11. The method of claim 1 wherein the one or more machine learning algorithms comprise an ensemble decision tree-based boosting algorithm.

12. The method of claim 11 wherein the one or more machine learning algorithms comprise a categorical boosting algorithm.

13. The method of claim 1 wherein the one or more machine learning algorithms comprise a shallow learning algorithm.

14. An apparatus comprising:
a processing device operatively coupled to a memory and configured:
to receive logistics operation order data, wherein the logistics operation order data identifies at least one logistics operation to be performed;
to analyze the logistics operation order data using one or more machine learning algorithms; and
to predict, based at least in part on the analyzing, a logistics provider to perform the at least one logistics operation.

15. The apparatus of claim 14 wherein the processing device is further configured to train the one or more machine learning algorithms with historical logistics data.

16. The apparatus of claim 15 wherein the one or more machine learning algorithms comprise a plurality of decision trees, and the plurality of decision trees are respectively trained with different portions of the historical logistics data.

17. The apparatus of claim 16 wherein, in analyzing the logistics operation order data, the processing device is configured:
to sequentially analyze the logistics operation order data with respective ones of the plurality of decision trees to generate respective predictions; and
to aggregate the respective predictions to determine the logistics provider to perform the at least one logistics operation.

18. An article of manufacture comprising a non-transitory processor-readable storage medium having stored therein program code of one or more software programs, wherein the program code when executed by at least one processing device causes said at least one processing device to perform the steps of:
receiving logistics operation order data, wherein the logistics operation order data identifies at least one logistics operation to be performed;
analyzing the logistics operation order data using one or more machine learning algorithms; and
predicting, based at least in part on the analyzing, a logistics provider to perform the at least one logistics operation.

19. The article of manufacture of claim 18 wherein the program code further causes said at least one processing device to perform the step of training the one or more machine learning algorithms with historical logistics data.

20. The article of manufacture of claim 19 wherein the one or more machine learning algorithms comprise a plurality of decision trees, and the plurality of decision trees are respectively trained with different portions of the historical logistics data.
